(19) United States
(12) Patent Application Publication
(10) Pub. No.: US 2025/0077884 A1
(43) Pub. Date: Mar. 6, 2025

(54) Method For Generating Artificial Defect Data With Position Control

(71) Applicant: VAZIL Company Co., Ltd., Busan (KR)

(72) Inventors: ANVARJON TURSUNOV, Busan (KR); SUNGWON KIM, Daegu (KR)

(73) Assignee: VAZIL Company Co., Ltd., Busan (KR)

(21) Appl. No.: 18/819,179

(22) Filed: Aug. 29, 2024

(30) Foreign Application Priority Data
Aug. 29, 2023 (KR) 10-2023-0113934

(51) Int. Cl. G06N 3/094

(52) U.S. Cl. CPC G06N 3/094

(57) ABSTRACT

Disclosed is a method for generating artificial defect data by using a neural network model, which is performed by one or more processors of a computing device according to an exemplary embodiment of the present disclosure.

The method may include: obtaining input data, and dividing the input data into a plurality of sub-data; generating one or more artificial defect data by using a first neural network model; transforming the one or more sub-data into the generated artificial defect data; and obtaining final artificial defect data based on a plurality of sub-data including the one or more transformed sub-data.

### CROSS-REFERENCE TO RELATED APPLICATIONS

This application claims priority to and the benefit of Korean Patent Application No. 10-2023-0113934 filed in the Korean Intellectual Property Office on 29 Aug. 2023, the entire contents of which are incorporated herein by reference.

### TECHNICAL FIELD

The present disclosure relates to a method for generating artificial defect data using a neural network model, and more particularly, a method for training a neural network model which generates artificial defect data, and generating artificial defect data with position control using the trained neural network model.

### BACKGROUND ART

In an automated vision-based control system for industrial products, such as a defect recognition classification model, a defective product may be produced relatively infrequently compared to the overall production volume. As a result, there is a problem that defect data on the defective product in an actual production line may be insufficiently obtained, and it is difficult to obtain sufficient defect data in terms of variety and quantity because labeling cost is high. Therefore, a very unbalanced dataset may be generated in which most products are good and a small number of products are defective in a database for training the defect recognition classification model, and such a data unbalance problem can have a significant impact on the performance of the defect recognition classification model. In particular, some types of defects in specific classes where data is scarce may be trained with biased models that cannot properly perform discrimination. To solve these problems, oversampling could be performed on data of a minority class by the existing method and a method of performing undersampling on data of a majority class could be performed. However, the sampling method had a problem that some of the original information in the data could be lost depending on the type of data augmentation used. For example, when an image is rotated, some of the original pixel values are lost, potentially affecting the performance of the defect recognition classification model, and there were cases where an overfitting problem occurs as the same augmented data is repeatedly used in a training process of the defect recognition classification model.

Therefore, there is a growing need for a method to increase the diversity of the training set by generating new defect data that is similar but not identical to the original defect data and controlling the position of the generated defect samples.

On the other hand, the present disclosure has been derived at least based on the technical background described above, but the technical problem or object of the present disclosure is not limited to solving the problems or disadvantages described above. That is, the present disclosure may cover various technical issues related to the content to be described below, in addition to the technical issues discussed above.

### SUMMARY OF THE INVENTION

The present disclosure has been made in an effort to provide training a neural network model generating artificial defect data using defect data, and generating artificial defect data using the trained neural network model.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method performed by a computing device. The method may include: obtaining input data, and dividing the input data into a plurality of sub-data; generating one or more artificial defect data by a first neural network model; transforming the one or more sub-data into the generated artificial defect data; and obtaining final artificial defect data based on a plurality of sub-data including the one or more transformed sub-data.

Alternatively, the obtaining of the input data, and dividing of the input data into the plurality of sub-data may include dividing the input data into a plurality of sub-data of a uniform size.

Alternatively, the one or more generated artificial defect data may include one or more defect data composed of a plurality of categories.

Alternatively, the transforming of the one or more sub-data into the generated artificial defect data may include calculating similarities between the plurality of sub-data and the one or more generated artificial defect data, and transforming the one or more sub-data into the generated artificial defect data based on the calculated similarities.

Alternatively, the transforming of the one or more sub-data into the generated artificial defect data based on the calculated similarities may include determining first sub-data and first artificial defect data having a maximum calculated similarity, and transforming the first sub-data into the first artificial defect data.

Alternatively, the transforming of the first sub-data into the first artificial defect data may include transforming the first sub-data into the first artificial defect data when the calculated similarities are greater than or equal to a predetermined threshold.

Alternatively, the generating of the one or more artificial defect data by the first neural network model may include generating one or more artificial defect data by using a generator included in the first neural network model.

Alternatively, the generator included in the first neural network model may include a first layer for expanding the size of input data and a second layer for extracting a feature of the input data.

Alternatively, the generator included in the first neural network model may further include a third layer for preventing an artifact.

Alternatively, the generator may include a plurality of layers, and the third layer may be located in a last layer among a plurality of layers of the generator.

Alternatively, the generator included in the first neural network model may correspond to a model trained based on an operation of generating sample defect data by using generator, and an operation of receiving reference defect data, and inputting the reference defect data and the sample defect data into a discriminator to calculate a loss function.

Alternatively, the obtaining of the final artificial defect data based on the plurality of sub-data including the one or more transformed sub-data may include obtaining the final artificial defect data by smoothing the plurality of sub-data including the one or more transformed sub-data by using a second neural network model.

Alternatively, the second neural network model may include a neural network model capable of processing at least one of encoding or decoding input data.

Another exemplary embodiment of the present disclosure provides a computer program stored in a computer-readable storage medium. The computer program may allow one or more processors to execute operations for generating artificial defect data by using a neural network model when the computer program is executed by the one or more processors, and the operations may include: an operation of obtaining input data, and dividing the input data into a plurality of sub-data; an operation of generating one or more artificial defect data by using a first neural network model; an operation of transforming the one or more sub-data into the generated artificial defect data; and an operation of obtaining final artificial defect data based on a plurality of sub-data including the one or more transformed sub-data.

Alternatively, the operation of transforming the one or more sub-data into the generated artificial defect data may include an operation of calculating similarities between the plurality of sub-data and the one or more generated artificial defect data, and an operation of transforming the one or more sub-data into the generated artificial defect data based on the calculated similarities.

Alternatively, the operation of transforming the one or more sub-data into the generated artificial defect data based on the calculated similarities may include an operation of determining first sub-data and first artificial defect data having a maximum calculated similarity, and an operation of transforming the first sub-data into the first artificial defect data.

Alternatively, the operation of transforming the first sub-data into the first artificial defect data may include an operation of transforming the first sub-data into the first artificial defect data when the calculated similarities are greater than or equal to a predetermined threshold.

Alternatively, the operation of obtaining the final artificial defect data based on the plurality of sub-data including the one or more transformed sub-data may include an operation of obtaining the final artificial defect data by smoothing the plurality of sub-data including the one or more transformed sub-data by using a second neural network model.

Yet another exemplary embodiment of the present disclosure provides a computing device. The device may include: at least one processor; and a memory, and the processor is configured to obtain input data, and divide the input data into a plurality of sub-data, generate one or more artificial defect data by using a first neural network model, transform the one or more sub-data into the generated artificial defect data, and obtain final artificial defect data based on a plurality of sub-data including the one or more transformed sub-data.

Still yet another exemplary embodiment of the present disclosure provides a data structure included in a computer-readable storage medium. The data structure may correspond to a parameter of a neural network, and the neural network performs the following steps at least partially based on the parameter, and the steps may include: obtaining input data, and dividing the input data into a plurality of sub-data; generating one or more artificial defect data by using a first neural network model; transforming the one or more sub-data into the generated artificial defect data; and obtaining final artificial defect data based on a plurality of sub-data including the one or more transformed sub-data.

According to the present disclosure, a neural network model which generates artificial defect data is trained and artificial defect data with position control is generated by using the trained neural network model to generate new defect data which is similar but not identical to original defect data, and control a position of a generated defect sample, and increase a diversity of a training set and solve a data unbalance problem.

Meanwhile, the effects of the present disclosure are not limited to the above-mentioned effects, and various effects can be included within the scope which is apparent to those skilled in the art from contents to be described below.

### BRIEF DESCRIPTION OF THE DRAWINGS

FIG. 1 is a block diagram of a computing device for generating artificial defect data using a neural network model according to an exemplary embodiment of the present disclosure.

FIG. 2 is a schematic diagram illustrating a network function according to an exemplary embodiment of the present disclosure.

FIG. 3 is a flowchart illustrating a method for generating artificial defect data using a neural network model according to an exemplary embodiment of the present disclosure.

FIG. 4 is a schematic diagram for describing a process of dividing input data into a plurality of sub-data, generating one or more artificial defect data by using a first neural network model, and calculating similarities between the plurality of sub-data and the one or more generated artificial defect data according to an exemplary embodiment of the present disclosure.

FIG. 5A is a schematic diagram for describing a structure a generation network (generator) generating artificial defect data according to an exemplary embodiment of the present disclosure.

FIG. 5B is a schematic diagram for describing a structure of a discrimination network (discriminator) used in a process of training the generation network (generator) included in the first neural network model according to an exemplary embodiment of the present disclosure.

FIG. 6 is a schematic diagram illustrating a process of determining whether a calculated similarities are greater than or equal to a predetermined threshold and transforming first sub-data into first artificial defect data based on the determination result according to an exemplary embodiment of the present disclosure.

FIG. 7 is a schematic diagram illustrating a process of obtaining final artificial defect data by smoothing a plurality of sub-data including one or more transformed sub-data using a second neural network model according to an exemplary embodiment of the present disclosure.

FIG. 8 is a schematic diagram for describing a structure of the second neural network model used in a process of smoothing a plurality of sub-data according to an exemplary embodiment of the present disclosure.

FIG. 9 is a simple and normal schematic diagram of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides.

To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

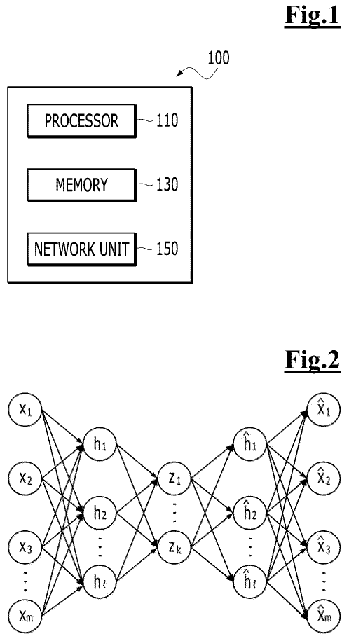

FIG. 1 is a block diagram of a computing device for generating artificial defect data using a neural network model according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. The processor 110 may perform calculations for training the neural network, which include processing of input data for training in deep learning (DL), extracting a feature in the input data, calculating an error, updating a weight of the neural network using backpropagation, and the like. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 110 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

FIG. 2 is a conceptual view illustrating a neural network according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

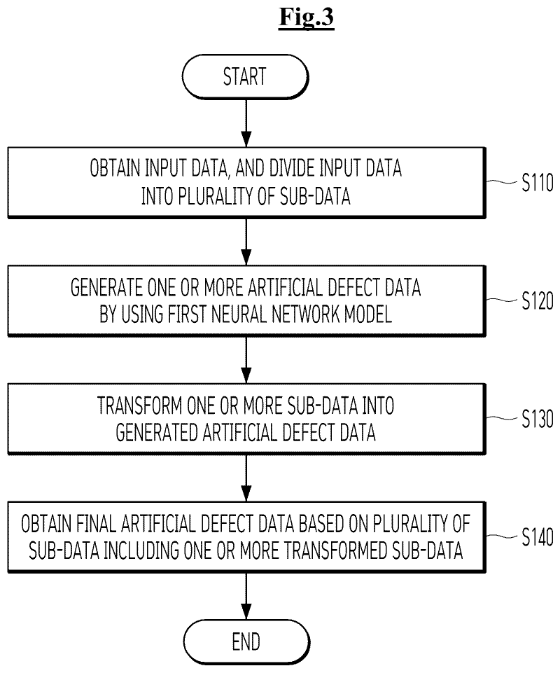

FIG. 3 is a flowchart illustrating a method for generating artificial defect data using a neural network model according to an exemplary embodiment of the present disclosure.

A computing device 100 according to an exemplary embodiment of the present disclosure may directly obtain or receive, from an external system, “information for generating artificial defect data using a neural network model”. The external system may be a server or database that stores and manages the information for generating the artificial defect data using the neural network model. The computing device 100 may use the information obtained directly or received from the external system as “input data for generating the artificial defect data using the neural network model. For example, the neural network model may include a model that generates surface defect image data for training a surface defect classification model of an article. However, the surface defect image data is only an example, and the present disclosure is not limited thereto and various examples may be included.

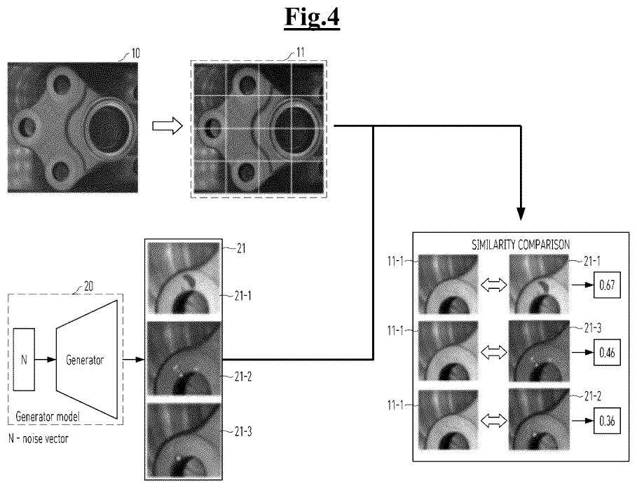

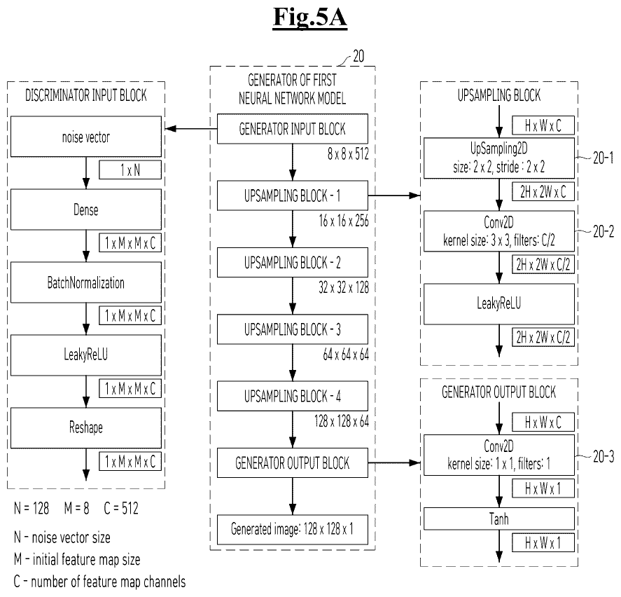

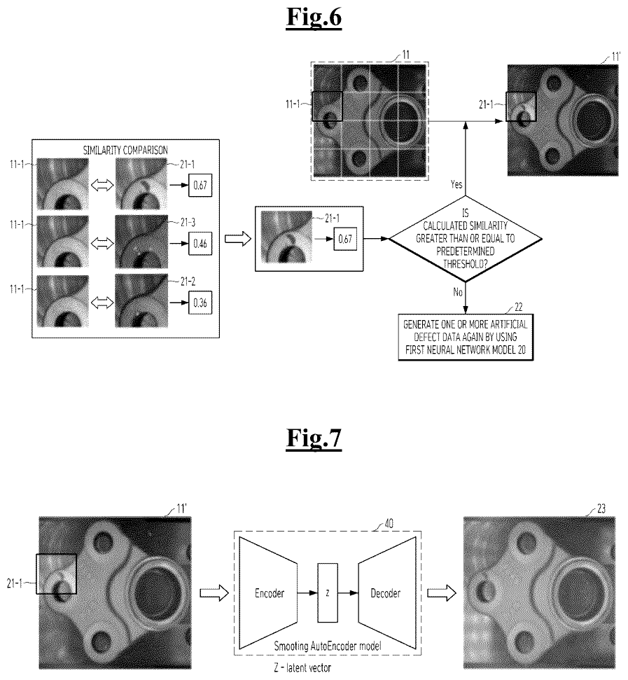

The computing device 100 may obtain input data and divide the input data into a plurality of sub-data (S110). At this time, the computing device 100 may divide the input data into a plurality of sub-data of uniform size. For example, the input data may include surface image data of the article, and the surface image data may include an image having a size of 512×512. In addition, the computing device 100 may divide the image having the size of 512×512 into 16 image patches having a size of 128×128, and each of the 16 divided image patches may indicate a specific position among positions 1 to 16. At this time, the image patch is only an example of the plurality of sub-data, and is not limited thereto, and various examples may be used as the plurality of sub-data. Meanwhile, the plurality of sub-data may be transformed into artificial defect data to be described later, and a detailed description thereof will be described later with reference to FIGS. 4 and 6.

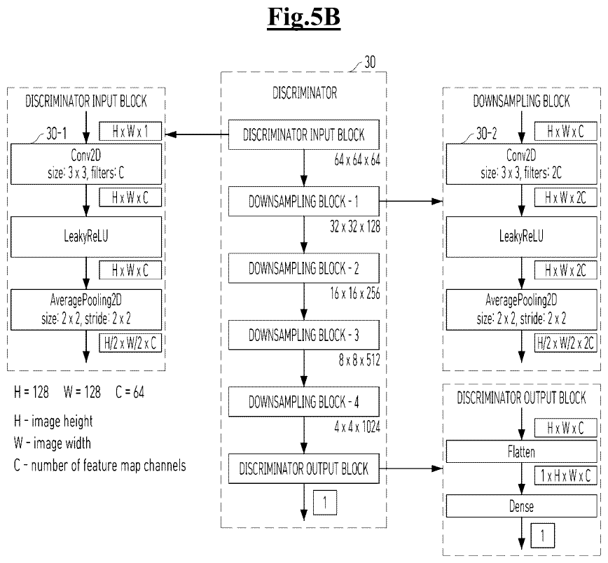

According to an exemplary embodiment of the present disclosure, the computing device 100 may generate one or more artificial defect data by using a first neural network model (S120). At this time, the artificial defect data may include one or more defect data composed of a plurality of categories. For example, the artificial defect data may include surface defect image data and may be composed of a plurality of categories such as scratches, cracks, stabbing, dents, stains, etc. However, the surface defect image data and categories such as scratches, cracks, stabbing, etc., are only an example, and the artificial defect data of the present disclosure is not limited thereto and various examples may be included. In addition, the artificial defect data may include a surface defect image patch having a size of 128×128, and the surface defect image patch may correspond to a specific position among positions 1 to 16 where the image having a size of 512×512 is divided into 16 image patches having the size of 128×128. At this time, the artificial defect data may be used in the process of transforming the one or more sub-data, and a specific description thereof will be provided later with reference to FIGS. 4 and 6. Meanwhile, the artificial defect data may be generated by using a generator included in the first neural network model. At this time, the generator included in the first neural network model may include a first layer for expanding the size of input data and a second layer for extracting a feature of the input data. Further, the generator may include a plurality of layers, and include a third layer for preventing an artifact. At this time, the third layer may be located at a last layer among the plurality of layers of the generator, and by using the third layer in an output of the generator, an artifact such as a checkerboard pattern or other distortions may be prevented from being generated in the generated artificial defect data. Hereinafter, a detailed description of the generator will be provided later with reference to FIG. 5A.

Meanwhile, the generator may correspond to a model trained based on an operation of generating sample defect data by using the generator, receiving reference defect data, and inputting the reference defect data and the sample defect data into a discriminator to calculate a loss function. For example, the first neural network model may include a generative adversarial network, and the first neural network model may be trained such that the calculated loss function is minimized. The generative adversarial network (hereinafter, referred to as GAN) may be trained through adversarial training of the generator and the discriminator. Specifically, the discriminator calculates a classification error by discriminating real/fake of fake data (e.g., sample defect data) and real data (e.g., reference defect data) generated from the generator, and the calculated error is backpropagated to update a parameter of the discriminator, so that the discriminator is trained to minimize the classification error. In addition, the generator generates the fake data (e.g., sample defect data) and delivers the generated fake data to the discriminator as an input, and the classification error of the discriminator is backpropagated to update the parameter of the generator, so that the generator may be trained to maximize the classification error of the discriminator. Accordingly, the generator may be trained to generate fake data (e.g., artificial defect data) that is difficult to distinguish from real data so as to maximize the classification error of the discriminator, and the discriminator may be trained to better distinguish between fake data that is difficult to distinguish from real data and real data. At this time, the discriminator may include a plurality of convolutional layers, but the plurality of convolutional layers included in the discriminator are merely examples and are not limited thereto, and various types of layers may be included in the discriminator. Hereinafter, a detailed description of the discriminator will be provided later with reference to FIG. 5B. Meanwhile, the order of steps S110 and S120 above is only an example, and the steps may be performed in the order of step S110->step S120, or the steps may be performed simultaneously regardless of the order, and the steps may also be performed in the order of step S120->step S110.

According to an exemplary embodiment of the present disclosure, the computing device 100 may transform one or more sub-data obtained through step S110 into the artificial defect data generated through step S120 (S130). At this time, the computing device 100 may calculate similarities between the plurality of sub-data and the one or more generated artificial defect data, and, based on the calculated similarities, transform the one or more sub-data into the generated artificial defect data. Specifically, the computing device 100 may determine first sub-data and first artificial defect data having a maximum calculated similarity, and when the calculated similarities are greater than or equal to a predetermined threshold, the computing device 100 may transform the first sub-data into the first artificial defect data. At this time, in the process of calculating the similarities, various examples which may be used by those skilled in the art, such as a cosine similarity, a Euclidean distance, and a similarity between embeddings, may be used. For example, the computing device 100 may transform a 128×128 sized image patch at a specific position among positions 1 to 16 of an input image of a 512×512 sized image into the “128×128 sized surface defect image patch generated through the generator”. Specifically, the computing device 100 may transform an image patch having the size of 128×128 at position 1 into a “first surface defect image patch having the size of 128×128 generated through the generator”, and transform an image patch having the size of 128×128 at position 5 into a “second surface defect image patch having the size of 128×128 generated through the generator”. Through this, a surface defect image may be obtained by controlling the location of the defect in the surface image data of the article, and various artificial defect data sets may be obtained, and hereinafter, a detailed description related thereto is described later with reference to FIGS. 4 and 6.

According to an exemplary embodiment of the present disclosure, the computing device 100 may obtain final artificial defect data based on a plurality of sub-data including “one or more sub-data transformed through step S130” (S140). For example, the computing device 100 may obtain the final artificial defect data by smoothing the plurality of sub-data including the one or more transformed sub-data using a second neural network model. At this time, the second neural network model may include a neural network model capable of processing at least one of encoding or decoding input data, and may include, but is not limited to, a latent diffusion model, a 3D diffusion model, an autoencoder (AE), a denoising autoencoder (DAE), a variational autoencoder (VAE), etc. Meanwhile, the smoothing may mean a process of alleviating or smoothing the detailed information of an image. Specifically, when the computing device 100 transforms only a portion of the input image of the size of 512×512 into the generated surface defect image patch, a color mismatch between pixels may occur. Accordingly, the computing device 100 obtains the final artificial defect data by smoothing using the second neural network model, thereby obtaining final artificial defect data in which the surface defect image patch is smoothly mixed with the remaining portion of the input image. In this regard, hereinafter, a specific process of obtaining the final artificial defect data through smoothing using the second neural network model by the computing device 100 is described later through FIG. 7.

FIG. 4 is a schematic diagram for describing a process of dividing input data into a plurality of sub-data, generating one or more artificial defect data by using a first neural network model, and calculating similarities between the plurality of sub-data and the one or more generated artificial defect data according to an exemplary embodiment of the present disclosure.

Referring to FIG. 4, the computing device 100 may obtain input data 10 and divide the input data into a plurality of sub-data 11. At this time, the computing device 100 may divide the input data 10 into a plurality of sub-data 11 of uniform size. For example, the input data 10 may include surface image data of an article, and the surface image data may include an image having a size of 512×512. In addition, the computing device 100 may divide the input data 10 having the size of 512×512 into 16 image patches having the size of 128×128, and each of the 16 divided image patches 11 may indicate a specific position among positions 1 to 16. At this time, positions 1 to 16 may be determined as in the following example, but are not limited thereto.

### Example

| | | | |
|---|---|---|---|
| Position 1 | Position 2 | Position 3 | Position 4 |
| Position 5 | Position 6 | Position 7 | Position 8 |
| Position 9 | Position 10 | Position 11 | Position 12 |
| Position 13 | Position 14 | Position 15 | Position 16 |

According to an exemplary embodiment of the present disclosure, the computing device 100 may generate one or more artificial defect data 21 by using a first neural network model. At this time, the artificial defect data 21 may include one or more defect data 21-1 to 21-3 composed of a plurality of categories. For example, the artificial defect data 21 may include surface defect image data and may be composed of a plurality of categories such as scratches, cracks, stabbing, dents, and stains. However, the surface defect image data and categories such as scratches, cracks, stabbing, etc., are only examples, and the artificial defect data of the present disclosure is not limited thereto and various examples may be included. In addition, the one or more artificial defect data 21 may include surface defect image patches 21-1 to 21-3 having the size of 128×128, and the surface defect image patches 21-1 to 21-3 may correspond to specific positions among positions 1 to 16 of the example. For example, the surface defect image patches 21-1 to 21-3 may include a surface defect image patch corresponding to position 5 of the example. In another embodiment, a first surface defect image patch 21-1 may correspond to position 5 of the example, and a second surface defect image patch 21-2 may correspond to position 10 of the example. Through this, the computing device 100 may obtain new defect data by using a combination of various artificial defect data for one input data 10 and control the number of defects included in the new defect data. In addition, the computing device 100 generates the artificial defect data having the size of 128×128 instead of generating artificial defect data for the entire data having the size of 512×512, thereby reducing the parameters of the first neural network model, making calculations lighter, and enabling stable training.

Meanwhile, when the artificial defect data is generated for the entire data having the size of 512×512, the complexity of the shape tends to be higher than that of the 128×128-size data, resulting in more artifacts. On the other hand, in the exemplary embodiment of the present disclosure, the computing device 100 generates the artificial defect data having the size of 128×128 instead of generating artificial defect data for the entire data having the size of 512×512, thereby generating artificial defect data with less influence of artifacts. However, the 512×512 and 128×128 are only examples to help understanding, and the exemplary embodiments of the present disclosure are not limited thereto, and input data or artificial defect data of various sizes may be used.

Additionally, the computing device 100 may calculate similarities between the plurality of sub-data 11 and one or more generated artificial defect data 21-1 to 21-3. For example, the computing device 100 may calculate a similarity between first sub-data 11-1 corresponding to the 5 position among the plurality of sub-data 11 and the one or more generated artificial defect data 21-1 to 21-3. Specifically, the similarity between the first sub data 11-1 and the first artificial defect data 21-1 may be calculated as 0.67, the similarity between the first sub data 11-1 and the second artificial defect data 21-2 may be calculated as 0.46, and the similarity between the first sub data 11-1 and the third artificial defect data 21-1 may be calculated as 0.36. At this time, in the process of calculating the similarity, various examples which may be used by those skilled in the art, such as a cosine similarity, a Euclidean distance, and a similarity between embeddings, may be used.

According to yet another exemplary embodiment of the present disclosure, the computing device 100 may calculate similarities of the one or more generated artificial defect data 21-1 to 21-3 among the plurality of sub-data 11, and determine the first sub-data 11-1 corresponding to the position where the calculated similarity is the highest. Thereafter, the calculated similarity may be used in the process of transforming one or more sub-data based on the artificial defect data 21, and a detailed description thereof will be provided later through FIG. 6.

Meanwhile, the artificial defect data 21 may be generated by using a generator 20 included in the first neural network model, and the generator 20 may correspond to an adversarially trained model based on a discriminator. Hereinafter, a detailed description of the generator 20 and the discriminator will be described later with reference to FIGS. 5A and 5B.

FIGS. 5A and 5B are schematic diagrams for describing a structure of the first neural network model for generating the artificial defect data according to an exemplary embodiment of the present disclosure.

At this time, the first neural network model may include a generative adversarial network, and the first neural network model may be trained such that the calculated loss function is minimized. The generative adversarial network (hereinafter, referred to as GAN) may be trained through adversarial training of the generator and the discriminator. Specifically, the discriminator calculates a classification error by discriminating real/fake of fake data (e.g., sample defect data) and real data (e.g., reference defect data) generated from the generator, and the calculated error is backpropagated to update a parameter of the discriminator, so that the discriminator is trained to minimize the classification error. In addition, the generator generates the fake data (e.g., sample defect data) and delivers the generated fake data to the discriminator as an input, and the classification error of the discriminator is backpropagated to update the parameter of the generator, so that the generator may be trained to maximize the classification error of the discriminator. Accordingly, the generator may be trained to generate fake data (e.g., artificial defect data) that is difficult to distinguish from real data so as to maximize the classification error of the discriminator, and the discriminator may be trained to better distinguish between fake data that is difficult to distinguish from real data and real data. In this regard, hereinafter, the generator will be described later in FIG. 5A, and the discriminator will be described later in FIG. 5B.

First, with reference to FIG. 5A for the structure of the generator 20, the generator 20 according to an exemplary embodiment of the present disclosure may include an input block, four upsampling blocks, and an output block. Specifically, the input block may include Dense, BatchNormalization, LeakyReLU, and Reshape layers. In this regard, the computing device 100 may process an input noise vector through the input block and transform the processed input noise vector into an 8×8×512 feature map. Further, each of the upsampling blocks may include a first layer 20-1 for expanding the size of input data and a second layer 20-2 for extracting a feature of the input data. In this regard, the computing device 100 may input a feature map output from the input block into the first layer 20-1 to enlarge the size of the feature map. Further, the computing device 100 may input the enlarged feature map into the second layer 20-2, and extract the feature of the input data. At this time, the first layer 20-1 for enlarging the size of the input data may be configured as an upsampling 2D layer (Upsampling2D), and the second layer 20-2 for extracting the feature of the input data may be configured as a convolution 2D layer (Conv2D). At this time, the second layer 20-2 for extracting the feature of the input data may correspond to a layer in which the size of the data input to the second layer 20-2 and the size of the data output from the second layer 20-2 are the same. For example, when the second layer 20-2 is a convolutional 2D layer (Conv2D) and the input data is an image, a stride is set to 1 and when the padding is set to be the same, the size of the data input to the second layer 20-2 and the size of the output data become the same, and in this case, a filter moves over the input image without skipping pixels, so that the size of the image may be maintained and data loss may be prevented. Further, the generator 20 may include a plurality of layers, and include a third layer 20-3 for preventing an artifact. At this time, the third layer 20-3 may be located at a last layer among the plurality of layers of the generator 20, and by using the third layer 20-3 in the output of the generator 20, an artifact such as a checkerboard pattern or other distortions may be prevented from being generated in the generated artificial defect data 21.

Specifically, referring to the example of FIG. 5A, the process in which the computing device 100 generates the artificial defect data 21 having the size of 128×128 by using the generator 20 may be configured as follows.

1) A random noise vector having a size of 1×128 is passed through the Dense layer, batch normalization is applied to enhance a stability of the training process, and passed through the LeakyReLU and Reshape layers to reshape the shape of the random noise vector to a shape of 8×8×512.

2) The random noise vector with the changed shape may be input to a first upsampling block including a first layer 20-1 having a kernel size of 2×2 and a stride of 2×2 and a second layer 20-2 having a kernel size of 2×2 and a number of filters of 256.

3) An output of the first upsampling block may be input to a second upsampling block including the first layer 20-1 and a 2-2^{nd} layer having the kernel size of 2×2 and a number of filters of 128.

4) An output of the second upsampling block may be input to a third upsampling block including the first layer 20-1 and a 2-3^{rd} layer having the kernel size of 2×2 and a number of filters of 64, and an output of the third upsampling block may be input to a fourth upsampling block including the first layer 20-1 and a 2-4^{th} layer having the kernel size of 2×2 and a number of filters of 32.

5) An output of the fourth upsampling block may be input to an output block including a third layer 20-3 having a number of filters of 1 and a kernel size of 1×1, and a Tan h activation function layer, and the artificial defect data having the size of 128×128 may be generated based on an output of the output block.

However, the processes 1) to 5) for generating the artificial defect data having the size of 128×128 are only examples and are not limited thereto, and artificial defect data of various sizes and shapes may be generated according to the exemplary embodiments of the present disclosure. In relation to the process of 5), when the computing device 100 uses a convolution kernel with a large kernel size such as 3×3, 5×5, or 7×7 in the process of generating the artificial defect data, an edge of the defective area may be mixed with an adjacent pixel. Therefore, there may be a problem in that the generated artificial defect data may appear blurry and the edges may not be clearly visible. On the other hand, the computing device 100 of the present disclosure may solve this problem by using a 1×1 third layer 20-3 in the process of generating the artificial defect data.

In addition, according to the exemplary embodiments of the present disclosure, compared to the generator of a DC-GAN consisting only of a conventional Conv2Dtranspose layer, layers for extracting features of input data (such as the second layer 20-2 and the third layer 20-3) are added, so that the neural network model may extract more complex and abstract features from the input data, thereby generating more detailed and complex artificial defect data. Specifically, the computing device 100 may generate highly detailed artificial defect data by using convolutional 2D layers in which the kernel size included in the generator 20 is 3×3 and the number of filters is 256, 128, 64, and 32, respectively. However, various numbers of filters may be used in addition to the example.

Meanwhile, according to an exemplary embodiment of the present disclosure, the computing device 100 may input sample defect data obtained through the generator into the discriminator 30 to calculate a loss function, and hereinafter, a specific process will be described later through FIG. 5B.

FIG. 5B is a schematic diagram for describing a structure of a discrimination network (discriminator) used in a process of training the generation network (generator) included in the first neural network model according to an exemplary embodiment of the present disclosure.

Referring to FIG. 5B for the structure of the discriminator 30 according to an exemplary embodiment of the present disclosure may include a plurality of layers, and the plurality of layers included in the discriminator may be hierarchically configured according to the number of filters. For example, the discriminator 30 may include a plurality of convolutional layers, and the number of filters of a first convolutional layer 30-1 among the plurality of convolutional layers may be different from the number of filters of a second convolutional layer 30-2 among the plurality of convolutional layers. More specifically, the second convolutional layer 30-2 included in the discriminator 30 may be a lower layer of the first convolutional layer 30-1, and the number of filters of the first convolutional layer 30-1 may be smaller than the number of filters of the second convolutional layer 30-2. At this time, the number of filters of the plurality of convolutional layers included in the discriminator 30 is configured to gradually increase, so that increasingly complex features within the image may be captured. In addition, in the discriminator 30, an average pooling layer with a stride of 2×2 is connected to outputs of the plurality of convolutional layers, so that feature maps, which are the outputs of the plurality of convolutional layers, may be down-sampled and spatial feature information may be preserved. At this time, the computing device 100 may compress information through downsampling in the discriminator 30 and expand a reception field of a subsequent layer. Through this, the computing device 100 may capture long-range dependencies and spatial relationships between different areas of the image. However, the terms first, second, etc. described throughout this specification are only used to distinguish different entities, and are not limited to first and second, and various examples may be used. Meanwhile, in FIG. 5B, C may represent the number of channels of the feature map, H may represent a height of the image, and W may represent a width of the image.

Specifically, referring to the example of FIG. 5B, the process in which the computing device 100 discriminates whether the sample defect data having the size of 128×128 and the reference defect data having the size of 128×128 are real/fake by using the discriminator 30 may be configured as follows.

1) The defect data (sample defect data or reference defect data) having a size of 128×128 may be input to a first convolutional layer 30-1 having a number of filters of 64 and a kernel size of 3×3.

2) An output of the first convolutional layer 30-1 may pass through the LeakyReLU layer and be input to an average pooling layer with a size of 2×2 and a stride of 2×2.

3) An output of the average pooling layer may be input to a first downsampling block including a second convolutional layer 30-2 having a number of filters of 128 and a kernel size of 3×3 and the average pooling layer having the size of 2×2 and the stride of 2×2.

3) An output of the first downsampling block may be input to a second downsampling block including a third convolutional layer having a number of filters of 256 and the kernel size of 3×3 and the average pooling layer having the size of 2×2 and the stride of 2×2.

4) An output of the second downsampling block may be input to a third downsampling block including a fourth convolutional layer having a number of filters of 512 and the kernel size of 3×3 and the average pooling layer having the size of 2×2 and the stride of 2×2.

5) An output of the third downsampling block may be input to a fourth downsampling block including a fifth convolutional layer having a number of filters of 1024 and the kernel size of 3×3 and the average pooling layer having the size of 2×2 and the stride of 2×2.

6) A flatten process of transforming a multidimensional array into a one-dimensional array may be performed on the output of the fourth downsampling block, and the real/fake of the input data may be determined by passing through the Dense layer.

A classification error may be calculated based on the result of discriminating whether the input data is real or fake, which is the output of the discriminator 30, a loss function may be calculated based on the calculated classification error, and the first neural network model may be trained so that the calculated loss function is minimized.

Meanwhile, the convolutional layers of the discriminator 30 are hierarchically configured so that the number of filters gradually increases, so the lower layer of the discriminator 30 (i.e., the first convolutional layer 30-1 with a relatively small number of filters) may be trained to discriminate simple features such as edges and corners, and the upper layer (i.e., the fifth convolutional layer with a relatively large number of filters) may be trained to discriminate complex features such as textures and detailed shapes. Accordingly, the plurality of layers included in the discriminator 30 are hierarchically configured and trained according to the number of filters, so that more diverse features may be trained in each layer of the discriminator 30. Through this, the computing device 100 may better discriminate real data and fake data generated from the generator 20. However, the plurality of convolutional layers included in the discriminator 30 are only examples and are not limited thereto, and various types of layers may be included in the discriminator. Meanwhile, the computing device 100 may generate the artificial defect data 21 by using the generator 20 trained through the exemplary embodiments, and the generated artificial defect data 21 may be used in the process of obtaining the final artificial defect data, and hereinafter, a detailed description thereof will be described later with reference to FIGS. 6 and 7.

FIG. 6 is a schematic diagram illustrating a process of determining whether a calculated similarities are greater than or equal to a predetermined threshold and transforming first sub-data into first artificial defect data based on the determination result according to an exemplary embodiment of the present disclosure.

Referring to FIG. 6, the computing device 100 may transform one or more sub-data 11 into the generated artificial defect data 21 based on the calculated similarities. Specifically, the computing device 100 may determine first sub-data 11-1 and first artificial defect data 21-1 having the maximum calculated similarity, and when the calculated similarity is greater than or equal to a predetermined threshold, the computing device 100 may transform the first sub-data into the first artificial defect data. On the other hand, when the calculated similarity is less than a predetermined threshold, one or more artificial defect data may be generated again by using the generator 20 of the first neural network model. For example, the computing device 100 may calculate the similarity between the first sub data 11-1 and the first artificial defect data 21-1 as 0.67, the similarity between the first sub data 11-1 and the second artificial defect data 21-2 as 0.46, and the similarity between the first sub data 11-1 and the third artificial defect data 21-1 as 0.36. At this time, the computing device 100 may determine the first artificial defect data 21-1 having the maximum calculated similarity. Thereafter, when the calculated similarity is greater than or equal to a predetermined threshold, the computing device 100 may transform the first sub-data 11-1 at position 5 into the first artificial defect data 21-1 having the maximum calculated similarity. For example, the predetermined threshold may be set to 0.6. At this time, since the similarity between the first sub data 11-1 and the first artificial defect data 21-1 is 0.67, which is greater than or equal to the threshold, the computing device 100 may transform the first sub data 11-1 at position 5 into the first artificial defect data 21-1 having the maximum calculated similarity. On the other hand, the predetermined threshold may be set to 0.7. In this case, since the similarity between the first sub-data 11-1 and the first artificial defect data 21-1 which is 0.67 is less than the threshold, the computing device 100 may generate one or more artificial defect data again by using the generator 20 of the first neural network model. Further, the computing device 100 may perform the exemplary embodiments again for one or more generated artificial defect data.

Meanwhile, the computing device 100 may obtain a plurality of sub-data 11′ including the one or more transformed sub-data 21-1 by transforming the first sub-data 11-1 into the first artificial defect data 21-1. Through this, the computing device 100 controls the location of the defect in the surface image data of the article to obtain the surface defect image and obtain various artificial defect datasets. In addition, through the exemplary embodiments of the present disclosure, a new surface defect image may be obtained through combinations of various defects from one data sample, thereby obtaining more various artificial defect datasets.

Additionally, the computing device 100 may obtain the final artificial defect data based on a plurality of sub-data including the one or more transformed sub-data, and hereinafter, a detailed description thereof will be described later with reference to FIG. 7.

FIG. 7 is a schematic diagram illustrating a process of obtaining final artificial defect data by smoothing a plurality of sub-data including one or more transformed sub-data using a second neural network model according to an exemplary embodiment of the present disclosure.

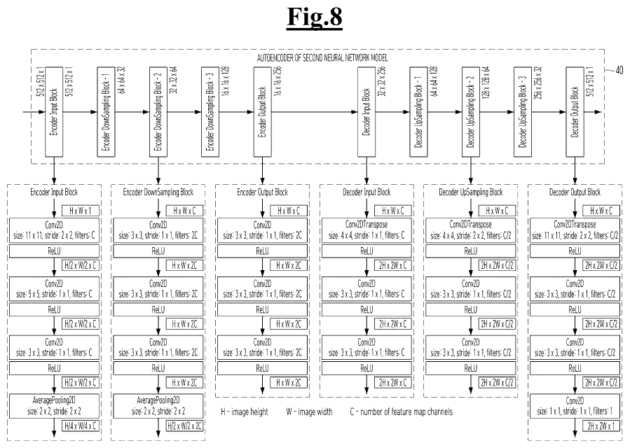

Referring to FIG. 7, the computing device 100 may obtain final artificial defect data 23 by smoothing the plurality of sub-data 11′ including the one or more transformed sub-data 21-1 by using the second neural network model 40. At this time, the second neural network model may include a neural network model capable of processing at least one of encoding or decoding input data, and may include, but is not limited to, a latent diffusion model, a 3D diffusion model, an autoencoder (AE), a denoising autoencoder (DAE), a variational autoencoder (VAE), etc. Meanwhile, the smoothing may mean a process of alleviating or smoothing the detailed information of an image. Specifically, when the computing device 100 transforms only a portion of the input data of the size of 512×512 into the first artificial defect data 21-1, a color mismatch between pixels may occur. Accordingly, the computing device 100 obtains the final artificial defect data 23 by smoothing using the second neural network model 40, thereby obtaining final artificial defect data in which the surface defect image patch is smoothly mixed with the remaining portion of the input image. In this regard, hereinafter, an exemplary structure of the second neural network model may be expressed as in FIG. 8.

FIG. 8 is a schematic diagram for describing a structure of the second neural network model used in a process of smoothing a plurality of sub-data according to an exemplary embodiment of the present disclosure.

Referring to FIG. 8, the second neural network model 40 may include a neural network model capable of processing at least one of encoding or decoding input data. Specifically, the second neural network model 40 may include an encoder block and a decoder block. More specifically, the encoder block may include an encoder input block, three encoder downsampling blocks, and an encoder output block. Further, the decoder block may include a decoder input block, three decoder upsampling blocks, and a decoder output block.

First, the encoder input block may include three convolutional layers A, B, and C and one average pooling layer. Convolutional layer A has a stride of 2×2, and a kernel size of 11×11, convolutional layer B has a stride of 1×1 and a kernel size of 5×5, and convolutional layer C has a stride of 1×1 and a kernel size of 3×3. In this regard, the computing device 100 may extract features of different sizes from input data through three convolutional layers A, B, and C of the encoder input block.

In addition, the three encoder downsampling blocks may each include three convolutional layers having the stride of 1×1 and the kernel size of 3×3 and one average pooling layer, and the encoder output block may include three convolutional layers having the stride of 1×1 and the kernel size of 3×3. At this time, the number of channels of the feature map included in the input data may be doubled each time passing through the three encoder downsampling blocks and the encoder output block. For example, when the number of channels of the feature map included in data input to the first encoder downsampling block is 16, the number of channels of the feature map included in data output from the first encoder downsampling block may be 32. Further, when the number of channels of the feature map included in data input to the encoder output block is 128, the number of channels of the feature map included in data output from the encoder output block may be 256. However, various numbers of channels may be used in addition to the example of the number of channels.

Afterwards, the data passing through the encoder output block may be input to the decoder input block. At this time, the decoder input block may include one convolution 2D transpose layer (Conv2DTranspose layer) having a stride of 2×2 and a kernel size of 4×4 and two convolutional layers having a stride of 1×1 and a kernel size of 3×3.

In addition, an output of the decoder input block may sequentially pass through three decoder upsampling blocks and the decoder output block. At this time, each of the three decoder upsampling blocks may include one convolution 2D transpose layer (Conv2DTranspose layer) having a stride of 2×2 and a kernel size of 4×4 and two convolutional layers having a stride of 1×1 and a kernel size of 3×3. Further, the decoder output block may include one convolution 2D transpose layer (Conv2DTranspose layer) having the stride of 2×2 and the kernel size of 11×11, two convolutional layers having the stride of 1×1 and the kernel size of 3×3, and the third layer 20-3 having the stride of 1×1, the kernel size of 1×1, and the number of filters of 1. At this time, the number of channels of the feature map included in the input data may be reduced by half each time passing through the three decoder upsampling blocks. For example, when the number of channels of the feature map included in data input to the first decoder upsampling block is 256, the number of channels of the feature map included in data output from the first decoder upsampling block may be 128. Further, when the number of channels of the feature map included in data input to the second decoder upsampling block is 128, the number of channels of the feature map included in data output from the second decoder upsampling block may be 64. However, various numbers of channels may be used in addition to the example of the number of channels. Additionally, an output of the third decoder upsampling block may be restored to an original value by passing through the third layer 20-3 in which the stride of the decoder output block is 1×1, the kernel size is 1×1, and the number of filters is 1. Through this, the computing device 100 reconfigures input data at high quality and obtains the final artificial defect data 23 by smoothing using the second neural network model 40, thereby obtaining final artificial defect data in which the surface defect image patch is smoothly mixed with the remaining portion of the input image.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an available designed data structure, a computing device can perform operations while using the resources of the computing device to a minimum. Specifically, the computing device can increase the efficiency of operation, read, insert, delete, compare, exchange, and search through the available designed data structure.

The data structure may be divided into a linear data structure and a non-linear data structure according to the type of data structure. The linear data structure may be a structure in which only one data is connected after one data. The linear data structure may include a list, a stack, a queue, and a dequeue. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The dequeue may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

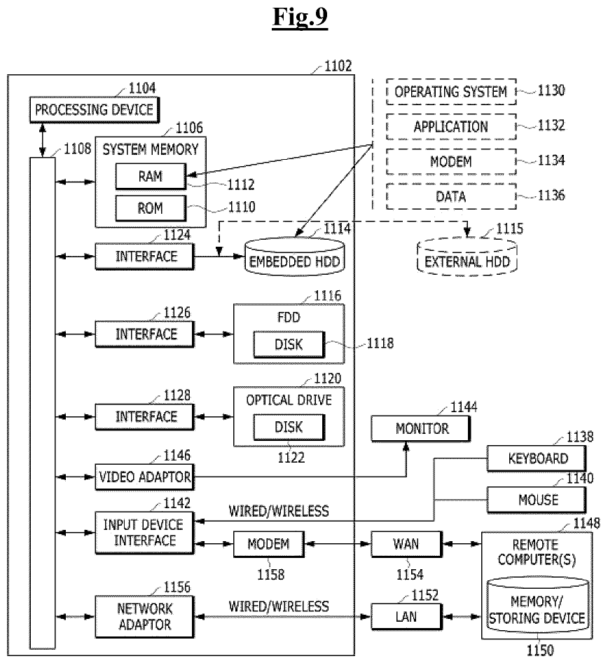

FIG. 9 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them. The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

1. A method for generating artificial defect data by using a neural network model, the method performed by a computing device, the method comprising:
obtaining input data, and dividing the input data into a plurality of sub-data;
generating one or more artificial defect data by using a first neural network model;
transforming the one or more sub-data into the generated artificial defect data; and
obtaining final artificial defect data based on a plurality of sub-data including the one or more transformed sub-data.

2. The method of claim 1, wherein the obtaining of the input data, and dividing of the input data into the plurality of sub-data includes:
dividing the input data into a plurality of sub-data of a uniform size.

3. The method of claim 1, wherein the one or more generated artificial defect data includes one or more defect data composed of a plurality of categories.

4. The method of claim 1, wherein the transforming of the one or more sub-data into the generated artificial defect data includes:
calculating similarities between the plurality of sub-data and the one or more generated artificial defect data, and
transforming the one or more sub-data into the generated artificial defect data based on the calculated similarities.

5. The method of claim 4, wherein the transforming of the one or more sub-data into the generated artificial defect data based on the calculated similarities includes:
determining first sub-data and first artificial defect data having a maximum calculated similarity; and
transforming the first sub-data into the first artificial defect data.

6. The method of claim 5, wherein the transforming of the first sub-data into the first artificial defect data includes:
transforming the first sub-data into the first artificial defect data when the calculated similarities are greater than or equal to a predetermined threshold.

7. The method of claim 1, wherein the generating of the one or more artificial defect data by the first neural network model includes:
generating one or more artificial defect data by using a generator included in the first neural network model.

8. The method of claim 7, wherein the generator included in the first neural network model includes:
a first layer for expanding the size of input data and a second layer for extracting a feature of input data.

9. The method of claim 8, wherein the generator included in the first neural network model further includes a third layer for preventing an artifact.

10. The method of claim 9, wherein the generator includes:
a plurality of layers, and
the third layer is located in a last layer among a plurality of layers of the generator.

11. The method of claim 7, wherein the generator included in the first neural network model corresponds to a model trained based on:
an operation of generating sample defect data by using generator; and
an operation of receiving reference defect data, and inputting the reference defect data and the sample defect data into a discriminator to calculate a loss function.

12. The method of claim 1, wherein the obtaining of the final artificial defect data based on the plurality of sub-data including the one or more transformed sub-data includes:
obtaining the final artificial defect data by smoothing the plurality of sub-data including the one or more transformed sub-data by using a second neural network model.

13. The method of claim 12, wherein the second neural network model includes a neural network model capable of processing at least one of encoding or decoding input data.

14. A computer program stored in a non-transitory computer-readable storage medium, wherein the computer program allows one or more processors to execute operations for generating artificial defect data by using a neural network model when the computer program is executed by the one or more processors, and the operations comprise:
an operation of obtaining input data, and dividing the input data into a plurality of sub-data;
an operation of generating one or more artificial defect data by using a first neural network model;
an operation of transforming the one or more sub-data into the generated artificial defect data; and
an operation of obtaining final artificial defect data based on a plurality of sub-data including the one or more transformed sub-data.

15. The computer program of claim 14, wherein the operation of transforming the one or more sub-data into the generated artificial defect data includes:
an operation of calculating similarities between the plurality of sub-data and the one or more generated artificial defect data, and
an operation of transforming the one or more sub-data into the generated artificial defect data based on the calculated similarities.

16. The computer program of claim 15, wherein the operation of transforming the one or more sub-data into the generated artificial defect data based on the calculated similarities includes:
an operation of determining first sub-data and first artificial defect data having a maximum calculated similarity, and
an operation of transforming the first sub-data into the first artificial defect data.

17. (canceled)

18. The computer program of claim 14, wherein the operation of generating the one or more artificial defect data by the first neural network model includes:
an operation of generating one or more artificial defect data by using a generator included in the first neural network model.

19. The computer program of claim 18, wherein the generator included in the first neural network model corresponds to a model trained based on:
an operation of generating sample defect data by using generator, and
an operation of receiving reference defect data, and inputting the reference defect data and the sample defect data into a discriminator to calculate a loss function.

20. The computer program of claim 14, wherein the operation of obtaining the final artificial defect data based on the plurality of sub-data including the one or more transformed sub-data includes:
an operation of obtaining the final artificial defect data by smoothing the plurality of sub-data including the one or more transformed sub-data by using a second neural network model.

21. A computing device comprising:
at least one processor; and
a memory,
wherein the at least one processor is configured to:
obtain input data, and divide the input data into a plurality of sub-data;
generate one or more artificial defect data by using a first neural network model;
transform the one or more sub-data into the generated artificial defect data; and
obtain final artificial defect data based on a plurality of sub-data including the one or more transformed sub-data.

22. (canceled)
